(19) United States
(12) Patent Application Publication
(10) Pub. No.: US 2012/0207070 A1
(43) Pub. Date: Aug. 16, 2012

(54) MOBILITY ENHANCEMENTS FOR LONG TERM EVOLUTION (LTE) DISCONTINUOUS RECEPTION (DRX) OPERATIONS

(75) Inventors: Hao Xu, San Diego, CA (US); Fatih Ulupinar, San Diego, CA (US)

(73) Assignee: QUALCOMM INCORPORATED, San Diego, CA (US)

(21) Appl. No.: 13/370,255

(22) Filed: Feb. 9, 2012

Related U.S. Application Data
(60) Provisional application No. 61/441,549, filed on Feb. 10, 2011.
(60) Provisional application No. 61/475,513, filed on Apr. 14, 2011.

(51) Int. Cl. H04W 52/02; H04W 36/00

(52) U.S. Cl. 370/311

(57) ABSTRACT

Certain aspects of the present disclosure provide methods and apparatus for enhancing mobility signaling for a user equipment (UE) operating in a discontinuous reception (DRX) mode. More specifically, by intelligently transitioning from a DRX connected state to an idle state before the expiration of an inactivity timer, signaling overhead may be reduced, and battery power may be conserved.

### CROSS-REFERENCE TO RELATED APPLICATION(S)

This application claims benefit of U.S. Provisional Patent Application Ser. No. 61/441,549 (Atty. Dkt. No. 110987P1), filed Feb. 10, 2011, and U.S. Provisional Patent Application Ser. No. 61/475,513 (Atty. Dkt. No. 110987P2), filed Apr. 14, 2011, both of which are herein incorporated by reference.

### BACKGROUND

1. Field

Certain aspects of the present disclosure generally relate to wireless communications and, more particularly, to mobility enhancements for Long Term Evolution (LTE) discontinuous reception (DRX) operations.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Mobile Telecommunications System (UMTS), a third generation (3G) mobile phone technology supported by the 3rd Generation Partnership Project (3GPP). UMTS includes a definition for a Radio Access Network (RAN), referred to as UMTS Terrestrial Radio Access Network (UTRAN). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications. For example, third-generation UMTS based on W-CDMA has been deployed all over the world. To ensure that this system remains competitive in the future, 3GPP began a project to define the long-term evolution of UMTS cellular technology. The specifications related to this effort are formally known as Evolved UMTS Terrestrial Radio Access (E-UTRA) and Evolved UMTS Terrestrial Radio Access Network (E-UTRAN), but are more commonly referred to by the project name Long Term Evolution, or LTE for short.

E-UTRAN is a RAN standard meant to be a replacement of the UMTS, High-Speed Downlink Packet Access (HSDPA) and High-Speed Uplink Packet Access (HSUPA) technologies specified in 3GPP release 5 and beyond. Unlike HSPA, LTE's E-UTRA is an entirely new air interface system, unrelated to and incompatible with W-CDMA. It provides higher data rates and lower latency and is optimized for packet data. E-UTRA uses orthogonal frequency-division multiple access (OFDMA) for the downlink and single-carrier frequency-division multiple access (SC-FDMA) on the uplink. In E-UTRAN, the protocol stack functions consist of the Media Access Control (MAC), Radio Link Control (RLC), Packet Data Convergence Protocol (PDCP), and Radio Resource Control (RRC) layers.

### SUMMARY

Certain aspects of the present disclosure generally relate to ways to enhance mobility signaling for a user equipment (UE) operating in a discontinuous reception (DRX) mode.

In an aspect of the disclosure, a method for wireless communications is provided. The method generally includes operating in a DRX mode in which a receiver of an apparatus is powered on during certain periods for receiving data from a first base station (BS), the receiver is powered off during other periods, and the apparatus is in a connected state with the first BS; detecting a triggering event before expiration of an inactivity timer; and transitioning from the connected state to an idle state based on the detection.

In an aspect of the disclosure, an apparatus for wireless communications is provided. The apparatus generally includes a receiver and a processing system. The processing system is typically configured to operate in a DRX mode in which the receiver is powered on during certain periods for receiving data from a first BS, the receiver is powered off during other periods, and the apparatus is in a connected state with the first BS; to detect a triggering event before expiration of an inactivity timer; and to transition the apparatus from the connected state to an idle state based on the detection.

In an aspect of the disclosure, an apparatus for wireless communications is provided. The apparatus generally includes means for operating in a DRX mode in which a receiver of the apparatus is powered on during certain periods for receiving data from a first BS, the receiver is powered off during other periods, and the apparatus is in a connected state with the first BS; means for detecting a triggering event before expiration of an inactivity timer; and means for transitioning from the connected state to an idle state based on the detection.

In an aspect of the disclosure, a computer-program product for wireless communications is provided. The computer-program product generally includes a computer-readable medium having code for operating in a DRX mode in which a receiver of an apparatus is powered on during certain periods for receiving data from a first BS, the receiver is powered off during other periods, and the apparatus is in a connected state with the first BS; detecting a triggering event before expiration of an inactivity timer; and transitioning from the connected state to an idle state based on the detection.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout and wherein:

FIG. 1 illustrates an example wireless communication system according to an aspect of the present disclosure.

FIG. 2 is a block diagram conceptually illustrating an example of a Node B in communication with a user equipment (UE) in a wireless communication system, according to an aspect of the present disclosure.

FIG. 3 illustrates an example handover (HO) procedure from a source Node B to a target Node B, according to an aspect of the present disclosure.

FIG. 4 illustrates an example UE-initiated idle state transition procedure, according to an aspect of the present disclosure.

FIG. 5 illustrates an example Random Access Channel (RACH) procedure with an idle state transition, according to an aspect of the present disclosure.

FIG. 6 is a flow diagram of example operations, which may be performed by a UE, for transitioning from a DRX connected state to an idle state, according to an aspect of the present disclosure.

FIG. 6A illustrates example components capable of performing the operations illustrated in FIG. 6.

### DESCRIPTION

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. UTRA includes Wideband-CDMA (W-CDMA) and Low Chip Rate (LCR). cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11 (WiFi), IEEE 802.16 (WiMAX), IEEE 802.20, Flash-OFDM®, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS and LTE are described in documents from an organization named “3rd Generation Partnership Project” (3GPP). cdma2000 is described in documents from an organization named “3rd Generation Partnership Project 2” (3GPP2). These various radio technologies and standards are known in the art. For clarity, certain aspects of the techniques are described below for LTE, and LTE terminology is used in much of the description below.

Single carrier frequency division multiple access (SC-FDMA) is a transmission technique that utilizes single carrier modulation at a transmitter side and frequency domain equalization at a receiver side. SC-FDMA has similar performance and essentially the same overall complexity as those of OFDMA. However, an SC-FDMA signal has lower peak-to-average power ratio (PAPR) because of its inherent single carrier structure. SC-FDMA has drawn great attention, especially in uplink communications where lower PAPR greatly benefits the mobile terminal in terms of transmit power efficiency. It is currently a working assumption for uplink multiple access scheme in 3GPP LTE, LTE-A, and E-UTRA.

### An Example Wireless Communication System

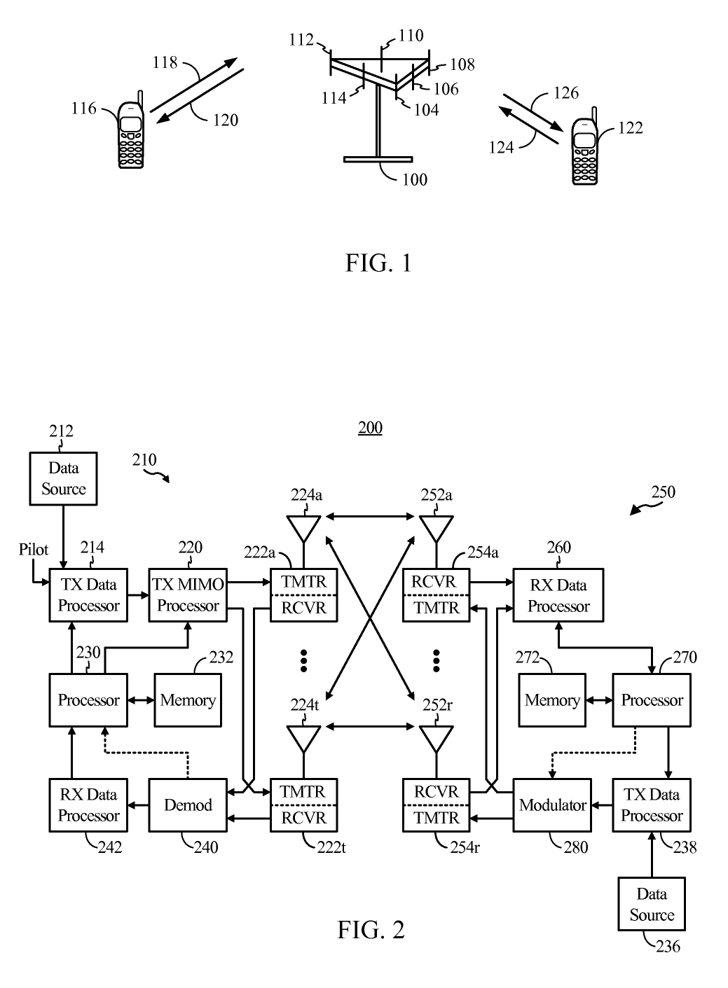

Referring to FIG. 1, a multiple access wireless communication system according to one aspect is illustrated. An access point 100 (AP) includes multiple antenna groups, one including antenna 104 and antenna 106, another including antenna 108 and antenna 110, and yet another including antenna 112 and antenna 114. In FIG. 1, only two antennas are shown for each antenna group; however, more or fewer antennas may be utilized for each antenna group. Access terminal 116 (AT) is in communication with antennas 112 and 114, where antennas 112 and 114 transmit information to access terminal 116 over forward link 120 (also known as a downlink) and receive information from access terminal 116 over reverse link 118 (also known as an uplink). Access terminal 122 is in communication with antennas 106 and 108, where antennas 106 and 108 transmit information to access terminal 122 over forward link 126 and receive information from access terminal 122 over reverse link 124. In an FDD system, communication links 118, 120, 124, and 126 may use different frequencies for communication. For example, forward link 120 may use a different frequency then that used by reverse link 118.

Each group of antennas and/or the area in which they are designed to communicate is often referred to as a sector of the access point. In an aspect, antenna groups each are designed to communicate to access terminals in a sector, of the areas covered by the access point 100.

In communication over forward links 120 and 126, the transmitting antennas of the access point 100 utilize beamforming in order to increase the signal-to-noise ratio (SNR) of forward links for the different access terminals 116 and 122. Also, an access point using beamforming to transmit to access terminals scattered randomly through the access point's coverage area causes less interference to access terminals in neighboring cells than an access point transmitting through a single antenna to all the access point's access terminals.

An access point (AP) may be a fixed station used for communicating with the terminals and may also be referred to as a base station (BS), a Node B, an evolved Node B (eNB), or some other terminology. An access terminal may also be called a mobile station (MS), user equipment (UE), a wireless communication device, terminal, user terminal (UT), or some other terminology.

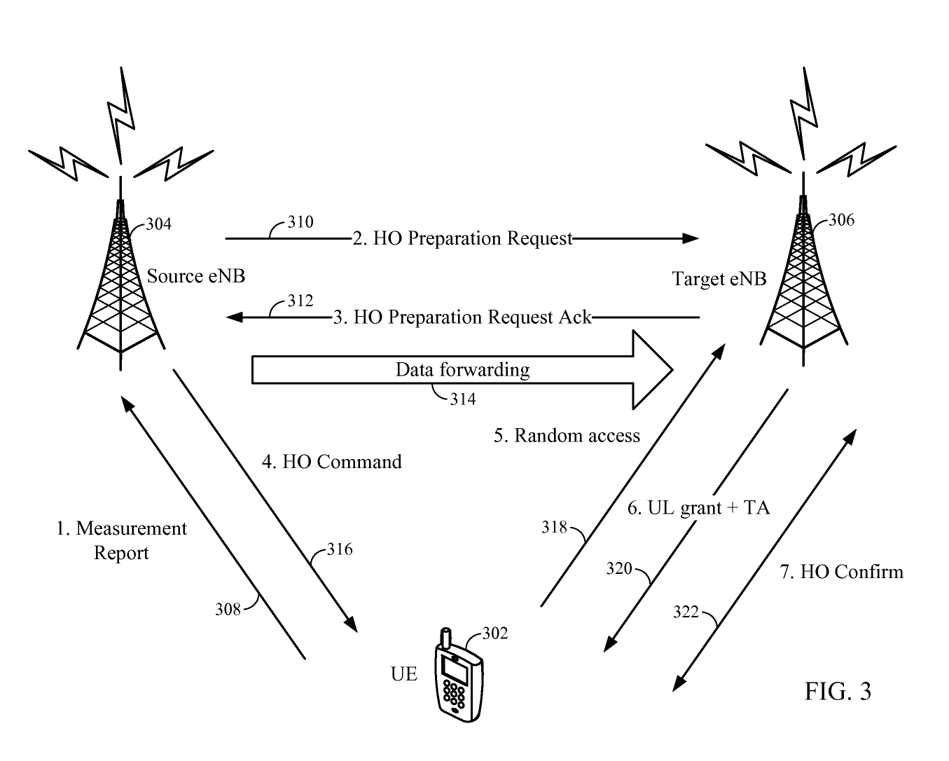

FIG. 2 is a block diagram of an aspect of a transmitter system 210 (also known as an access point) and a receiver system 250 (also known as an access terminal) in a MIMO system 200. At the transmitter system 210, traffic data for a number of data streams is provided from a data source 212 to a transmit (TX) data processor 214.

In an aspect, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain aspects, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use. Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reverse link message transmitted by the receiver system 250. Processor 230 then determines which pre-coding matrix to use for determining the beamforming weights and then processes the extracted message.

In an aspect, logical channels are classified into Control Channels and Traffic Channels. Logical Control Channels comprise Broadcast Control Channel (BCCH) which is a downlink (DL) channel for broadcasting system control information. Paging Control Channel (PCCH) is a DL channel that transfers paging information. Multicast Control Channel (MCCH) is a point-to-multipoint DL channel used for transmitting Multimedia Broadcast and Multicast Service (MBMS) scheduling and control information for one or several MTCHs. Generally, after establishing a Radio Resource Control (RRC) connection, this channel is only used by UEs that receive MBMS (Note: old MCCH+MSCH). Dedicated Control Channel (DCCH) is a point-to-point bi-directional channel that transmits dedicated control information used by UEs having an RRC connection. In an aspect, Logical Traffic Channels comprise a Dedicated Traffic Channel (DTCH), which is a point-to-point bi-directional channel, dedicated to one UE, for the transfer of user information. Also, a Multicast Traffic Channel (MTCH) is a point-to-multipoint DL channel for transmitting traffic data.

In an aspect, Transport Channels are classified into DL and uplink (UL). DL Transport Channels comprise a Broadcast Channel (BCH), Downlink Shared Data Channel (DL-SDCH), and a Paging Channel (PCH), the PCH for support of UE power saving (DRX cycle is indicated by the network to the UE), broadcasted over entire cell and mapped to physical layer (PHY) resources which can be used for other control/traffic channels. The UL Transport Channels comprise a Random Access Channel (RACH), a Request Channel (REQCH), an Uplink Shared Data Channel (UL-SDCH), and a plurality of PHY channels. The PHY channels comprise a set of DL channels and UL channels.

The DL PHY channels comprise:

Common Pilot Channel (CPICH)

Synchronization Channel (SCH)

Common Control Channel (CCCH)

Shared DL Control Channel (SDCCH)

Multicast Control Channel (MCCH)

Shared UL Assignment Channel (SUACH)

Acknowledgement Channel (ACKCH)

DL Physical Shared Data Channel (DL-PSDCH)

UL Power Control Channel (UPCCH)

Paging Indicator Channel (PICH)

Load Indicator Channel (LICH)

The UL PHY Channels comprise:

Physical Random Access Channel (PRACH)

Channel Quality Indicator Channel (CQICH)

Acknowledgement Channel (ACKCH)

Antenna Subset Indicator Channel (ASICH)

Shared Request Channel (SREQCH)

UL Physical Shared Data Channel (UL-PSDCH)

Broadband Pilot Channel (BPICH)

In an aspect, a channel structure is provided that preserves low PAR (at any given time, the channel is contiguous or uniformly spaced in frequency) properties of a single carrier waveform.

For the purposes of the present document, the following abbreviations apply:

AM Acknowledged Mode

AMD Acknowledged Mode Data

ARQ Automatic Repeat Request

BCCH Broadcast Control CHannel

BCH Broadcast CHannel

C- Control-

CCCH Common Control CHannel

CCH Control CHannel

CCTrCH Coded Composite Transport Channel

CP Cyclic Prefix

CRC Cyclic Redundancy Check

CTCH Common Traffic CHannel

DCCH Dedicated Control CHannel

DCH Dedicated CHannel

DL DownLink

DSCH Downlink Shared CHannel

DTCH Dedicated Traffic CHannel

FACH Forward link Access CHannel

FDD Frequency Division Duplex

L1 Layer 1 (physical layer)

L2 Layer 2 (data link layer)

L3 Layer 3 (network layer)

LI Length Indicator

LSB Least Significant Bit

MAC Medium Access Control

MBMS Multimedia Broadcast Multicast Service

MCCH MBMS point-to-multipoint Control CHannel

MRW Move Receiving Window

MSB Most Significant Bit

MSCH MBMS point-to-multipoint Scheduling CHannel

MTCH MBMS point-to-multipoint Traffic CHannel

PCCH Paging Control CHannel

PCH Paging CHannel

PDU Protocol Data Unit

PHY PHYsical layer

PhyCH Physical CHannels

RACH Random Access CHannel

RB Resource Block

RLC Radio Link Control

RRC Radio Resource Control

SAP Service Access Point

SDU Service Data Unit

SHCCH SHared channel Control CHannel

SN Sequence Number

SUFI SUper FIeld

TCH Traffic CHannel

TDD Time Division Duplex

TFI Transport Format Indicator

TM Transparent Mode

TMD Transparent Mode Data

TTI Transmission Time Interval

U- User-

UE User Equipment

UL UpLink

UM Unacknowledged Mode

UMD Unacknowledged Mode Data

UMTS Universal Mobile Telecommunications System

UTRA UMTS Terrestrial Radio Access

UTRAN UMTS Terrestrial Radio Access Network

MBSFN multicast broadcast single frequency network

MCE MBMS coordinating entity

MCH multicast channel

DL-SCH downlink shared channel

H MBMS control channel

CH physical downlink control channel

CH physical downlink shared channel

### Example DRX Mode Operations

With the ever-increasing popularity of smart phones, there are many new challenges for the design of wireless systems, including power consumption and signaling demands. For example, instead of being awake only for the typically small percentage of talk time, smart phones are awake much more often. Applications, such as e-mail or social networking, may send “keep-alive” message every 20 to 30 minutes, for example. Such applications often use many small and bursty data transmissions that may entail a significantly larger amount of control signaling. Some system level evaluations have identified control channel limitations in addition to traffic channel limitations.

Discontinuous Reception (DRX) is a method used in mobile communication to reduce power consumption, thereby conserving the battery of the mobile device. The mobile device and the network negotiate phases in which data transfer occurs, where the mobile device's receiver is turned on. During other times, the mobile device turns its receiver off and enters a low power state. There is usually a function designed into the protocol for this purpose. For example, the transmission may be structured in slots with headers containing address details so that devices may listen to these headers in each slot to decide whether the transmission is relevant to the devices or not. In this case, the receiver may only be active at the beginning of each slot to receive the header, conserving battery life. Other DRX techniques include polling, whereby the device is placed into standby for a given amount of time and then a beacon is sent by the base station periodically to indicate if there is any data waiting for it.

In LTE, DRX is controlled by the RRC protocol. RRC signaling sets a cycle where the UE's receiver is operational for a certain period of time, typically when all the scheduling and paging information is transmitted. The serving evolved Node B (eNB) knows that the UE's receiver is completely turned off and is not able to receive anything. Except when in DRX, the UE's receiver may most likely be active to monitor the Physical Downlink Control CHannel (PDCCH) to identify downlink data. During DRX, the UE's receiver may be turned off. In LTE, DRX also applies to the RRC Idle state with a longer cycle time than active mode.

There are two RRC states for a UE: (1) RRC_Idle where the radio is not active, but an identifier (ID) is assigned to the UE and tracked by the network; and (2) RRC_Connected with active radio operation having context in the eNB.

In active mode, there is a dynamic transition between long DRX and short DRX. Long DRX has a longer “off” duration. Durations for long and short DRX are configured by the RRC protocol. The transition is determined by the eNB (e.g., with MAC commands) or by the UE based on an inactivity timer. For example, a lower duty cycle may be used during a pause in speaking during a voice over Internet protocol (VOIP) call; packets are arriving at a lower rate, so the UE can remain off for a longer period of time. When speaking resumes, this results in lower latency. Packets are arriving more often, so the DRX interval is reduced during this period.

DRX currently has issues with mobility. When in DRX mode, the UE is typically RRC connected to the serving eNB. In the RRC connected state, whenever the UE leaves a first eNB's coverage area and enters a second eNB's coverage area, the UE may typically be handed over from the first eNB (i.e., the source eNB) to the second eNB (i.e., the target eNB). The exact trigger point may occur with an A3 event, as defined in the LTE specification.

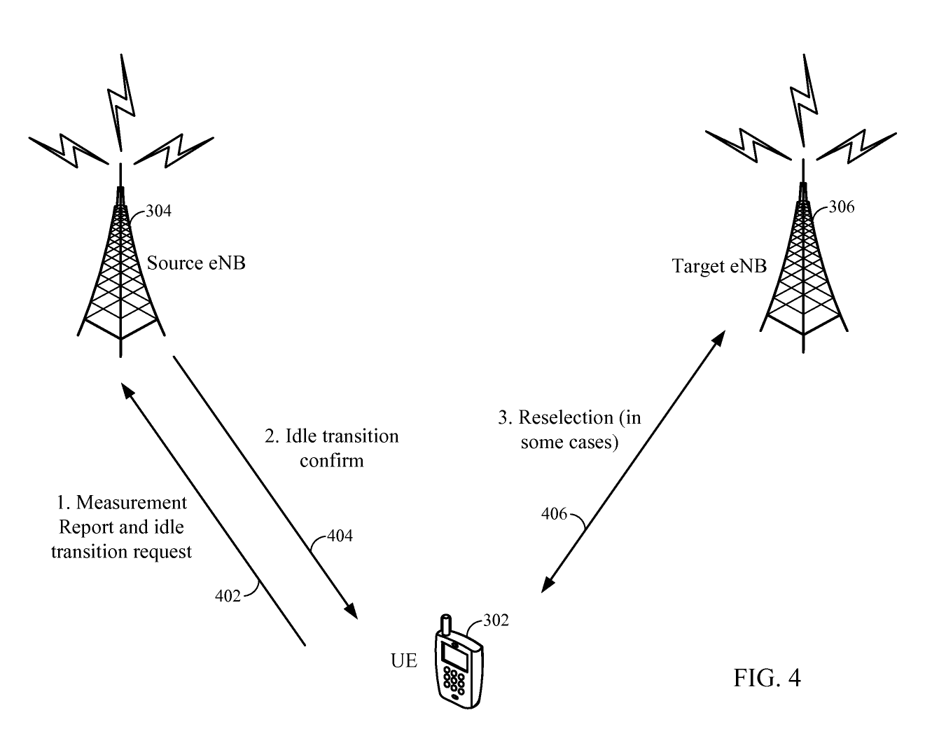

FIG. 3 illustrates an example handover (HO) procedure, in which a UE 302 is handover over from a source eNB 304 to a target eNB 306. The UE 302 may measure a reference signal received power (RSRP) based on reference signals received from the source eNB 304. The UE 302 may transmit a measurement report at 308 indicating the RSRP. The source eNB 304 may determine that the RSRP is too low (i.e., below a threshold) or is decreasing, and at 310, the source eNB 304 may send an HO preparation request to the target eNB 306. This request may be sent via the X2 backhaul link between the eNBs 304, 306. At 312, the target eNB 306 may send an HO preparation request acknowledgment (ACK) to the source eNB, acknowledging receipt of the HO preparation request and accepting the handover. At 314, the source eNB may forward data for communicating with the UE 302 to the target eNB 306. The source eNB 304 may then transmit a HO command to the UE 302 at 316, instructing the UE to associate with the target eNB 306.

At 318, the UE 302 may use a Random Access Channel (RACH) procedure to access the target eNB 306. At 320, the target eNB 306 may transmit an uplink (UL) grant and tracking area (TA) information to the UE 302. At 322, the UE 302 and the target eNB 306 may confirm the handover has been completed.

The handover operation, as illustrated in FIG. 3, may incur significant signaling overhead, both over-the-air (OTA) as well as on the X2 link between the eNBs 304, 306. While this signaling overhead may be unavoidable when the UE 302 is actively communicating data or voice, there is a lot of unnecessary overhead when the UE 302 is in DRX mode and communicating with the network only intermittently.

When the UE is in DRX mode instead of active communications, it is wasteful to perform handover of the UE from cell to cell just to keep the UE in the RRC_Connected state. One solution is for the UE to enter the RRC_Idle state whenever an inactivity timer expires. For mobility purposes, it is much more efficient to keep the UE in the idle state, where only cell reselection occurs while the UE is moving, rather than a complete HO procedure from cell to cell during mobility. However, this approach has other overhead issues because now, whenever the UE has a small keep-alive message to send, the UE may most likely proceed through the entire RACH procedure, along with the connection setup, again. In other words, always forcing the UE into the idle state causes delays to the bursty traffic.

Accordingly, what is needed are techniques and apparatus for lowered signaling overhead and battery power savings, especially for smart phone applications during mobility.

### Example UE-Initiated Idle State Transition

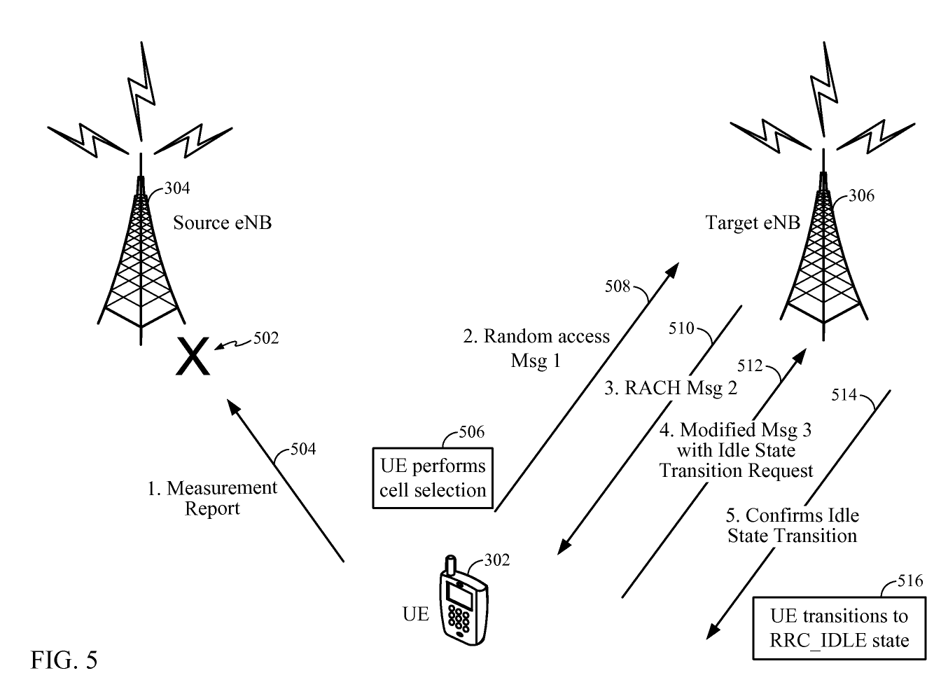

For certain aspects, as illustrated in FIG. 4, a UE 302 may initiate an idle state transition. While in DRX mode, the UE 302 may still monitor the reference signal received power (RSRP) from the serving cell (i.e., source eNB 304) and perform RSRP measurements from neighboring cells (including, for example, the target eNB 306). In this manner, the UE will know of an imminent handover. Instead of waiting for the A3 event and to be handed over to the target eNB 306, the UE 302 may initiate a request to go to the idle state directly to the source eNB 304 when a handover is imminent.

For example, the UE 302 may transmit an idle state transition request at 402 to the source eNB 304. For certain aspects, the idle state transition request may be transmitted along with a measurement report of the RSRP from the source eNB 304 as illustrated in FIG. 4. The source eNB 304 may process the received request and may then transmit a message to the UE 302 at 404 confirming the idle state transition. After receiving this confirmation, the UE may then enter the idle state. Once the UE 302 enters the idle state, further mobility operations may only involve a cell reselection at 406 instead of a handover, which significantly reduces signaling overhead.

For certain aspects, the UE may initiate a connection release (i.e., depart from the connection state) even without mobility of the UE. For example, the UE may decide that it is more efficient or otherwise better to enter into the idle state instead of remaining in the DRX connected state. In any event, the UE may transmit an idle state transition request at 402 to the serving eNB and enter the idle state after receiving the confirmation at 404, as described above. Reasons for transitioning to the idle state may include, for example: (1) the UE may have limited power and would like to transition to the idle state to avoid periodic monitoring during the “DRX on” period; (2) the UE has no application layer activity; or (3) the UE need not transmit or receive any data for an extended period.

### Example RACH Procedure for Connection Release

In the DRX mode, the measurement accuracy, as well as the reporting delay may lead the UE into radio link failure (RLF). Therefore, communications to the serving eNB may not always be readily available. In this case, it may be desirable to have the UE associate with a neighboring eNB and directly enter the idle state.

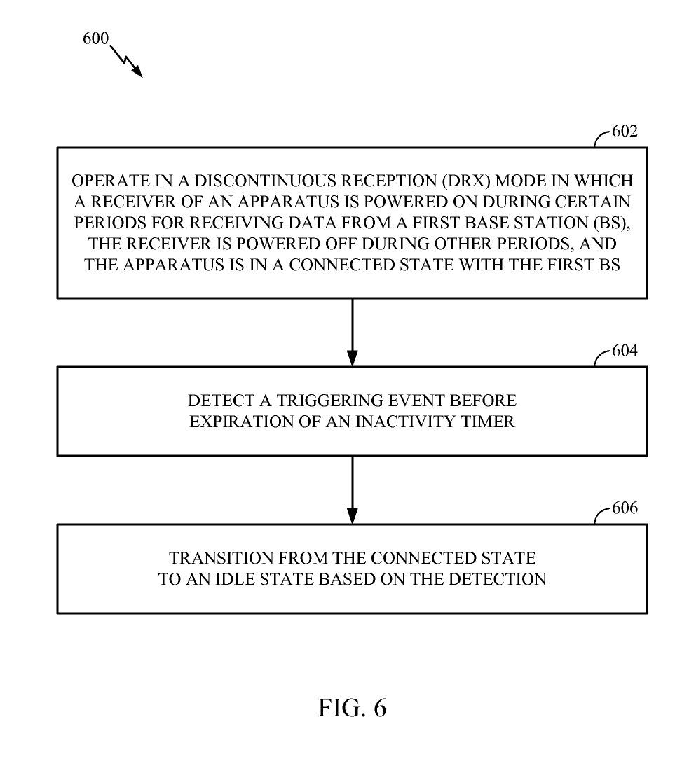

FIG. 5 illustrates a new Random Access Channel (RACH) procedure for having the UE 302 transition from the connected state to the idle state. A RLF 502 may prevent a measurement report based on the RSRP from reaching the source eNB 304. Due to the RLF 502, the UE 302 may not have had time to send an idle state transition request to the source eNB 304 (as occurred at 402 in FIG. 4). Therefore, the UE may perform cell reselection at 506, thereby selecting a target eNB 306. At 508, the UE 302 may transmit an RACH Msg 1 to the target eNB 306. The target eNB 306 may respond to the UE 302 with an RACH Msg 2 at 510.

At 512, a modified RACH Msg 3 may be transmitted from the UE 302 to the target eNB 306. The RACH Msg 3 may be modified with the idle state transition request for the UE 302 to enter the idle state. For certain aspects, the request may be indicated by a single bit in Msg 3. At 514, the target eNB 306 may process the request and transmit a message (e.g., RACH Msg 4) indicating confirmation of the idle state transition. If the UE 302 receives the idle state transition confirmation, the UE 302 may transition to the idle state (e.g., RRC_Idle) at 516. In other words, the UE may directly enter the idle state after receiving Msg 4, instead of going through the RRC connection setup and the remainder of the handover procedure.

In a handover situation after RLF, Msg 3 may include the physical cell identifier (PCI) and the cell radio network temporary identifier (C-RNTI) of the source eNB 304. This may also be extended to the non-handover case when the UE loses UL synchronization to its serving eNB. In this non-handover scenario, Msg 3 transmitted from the UE to the serving eNB may include the PCI and C-RNTI of the serving eNB.

For certain aspects, the PCI of the source (or serving) eNB, the C-RNTI of the source (or serving) eNB, the request for idle state transition, or any combination thereof may be transmitted in RACH Msg 5 (not shown), rather than in Msg 3. The advantage of putting at least some of this information in Msg 5 is that Msg 5 is secured and has protection for the content of the message. The disadvantage, however, is that one more subsequently transmitted message is used to signal the transition, which slightly increases the signaling overhead and battery consumption.

### Example Autonomous Idle State Transition

According to certain aspects, an autonomous idle state transition may occur. For example, the UE may autonomously enter the idle state if the UE is in DRX mode if mobility happens (e.g., when the UE moves from the coverage area of a first cell to a second cell's coverage area). The UE may determine that mobility is occurring by using Doppler estimation, a Global Positioning System (GPS) update, or RSRP measurements from the serving cell and neighbor cells. This autonomously initiated transition will save all of the handover overhead until the UE has a DL packet to receive or a UL packet to transmit. However, one potential drawback is that the serving eNB is unaware of the UE's idle state transition. Therefore, if there is a DL packet to send to the UE, the serving eNB may still attempt to send the packet to the UE during the “DRX on” period (i.e., while the UE's receiver is powered on). This packet is retransmitted until RLF is declared and the paging procedure is triggered to deliver the packet. Due to this, a large delay may be incurred to deliver the packet. Typically, however, most of the Transmission Control Protocol (TCP) connections are UL-initiated, so this loss may not be significantly large.

The UE may autonomously initiate an idle state transition for other reasons, as well. For example, the UE may initiate the idle state transition if the UE has limited power and would like to stay in idle mode to avoid periodic monitoring during the “DRX on” period. As another example, the UE may autonomously initiate the idle state transition if the UE has no application layer activity. For other aspects, the UE may transition to the idle state if the UE need not transmit or receive data for an extended time.

### Example eNB-Initiated Idle State Transition

Rather than a UE initiating the idle state transition, an eNB may initiate the UE's transition to the idle state for certain aspects. In this case, the eNB may compel the UE to enter the idle state if the eNB decides it is more efficient for the UE to do so. For example, the eNB may preemptively release the UE when the measurement reports show that a UE in DRX mode is moving away from the eNB. This operation may also be initiated if the UE does not have much data activity.

In yet another aspect of an eNB-initiated idle state transition, the target eNB may also initiate the idle state transition. In this approach, if the source eNB receives measurement reports from the UE and determines that the UE is moving away from the source eNB towards the target eNB, the source eNB may send a message to the target eNB (e.g., via the X2 backhaul link) such that the target eNB may compel the UE to enter the idle state after the UE begins the RACH procedure with the target eNB. Initiating the idle state transition may be performed in this manner because while the UE is in transition to the target eNB, the source eNB may not be able to reach the UE to instruct the UE to enter the idle state.

For certain aspects of the eNB-initiated idle state transition process, the UE may transmit information related to a user interface (UI) for the device, such as UI status information. This information may include, for example, whether the display (such as a touch-screen display) for the UE is currently powered on or off. The UE may also send the information to another network entity in lieu of or in addition to the eNB. For certain aspects, the UI status information may be sent in an RRC connection request message, which is used by the UE to request communication with the eNB when the UE is in an idle state. The eNB—upon receiving notification that the screen of the UE is off along with an RRC connection request message—may interpret this to mean that the subsequently expected traffic is most likely to be keep-alive data. For certain aspects, the UI status information may also be transmitted when the UE transmits measurement reports to the eNB. Typically, a measurement report will be sent to the serving eNB based on the UE detecting a deteriorating signal or a better signal. Thus, the eNB may receive this information right before a handover event. For certain aspects, the UI status information may be sent in a MAC layer message, such as a MAC control element (CE). In this manner, UI status information may be sent in a faster, more lightweight, dedicated channel that is very low cost.

Using the UI status information, the eNB may be able to determine whether transmissions from the UE are background “keep-alive” messages or user-initiated data. For example, if the UI status information indicates that the UE's display is powered on, it is more likely that more traffic will be expected from the UE based on the assumption that the UE's display will not be on unless the user is interacting with the UE. As another example, the UE status information may indicate whether the UE's speaker is on (or outputting signal), in which case it may be assumed that the user is either on a phone call or listening to audio, which may be streaming. Status information from other UI devices (e.g., the UE's keyboard (or keypad), buttons, microphone, or camera) may be used to distinguish between keep-alive messages or user-initiated data in a similar manner.

Based on this determination, the eNB may then decide a DRX setting for the UE. For certain aspects, the eNB may use this determination in conjunction with the UE's mobility information to decide whether to put the UE in the idle state or in the DRX connected state. For example, if the eNB is notified that the display of the UE is powered on and the UE is mobile (i.e., moving away from the eNB), then the eNB may place the UE into the DRX connected state. Conversely, if the display of the UE is off and the UE is mobile, then the eNB may initiate an idle state transition for the UE since it is likely that the UE will not be sending data soon. In the latter case, the UE may leave the coverage area of the serving eNB and may perform registration when the UE detects a new tracking area pursuant to normal operations.

For other aspects, rather than (or in addition to) sending the UI information to the eNB, the UE may consider the UI information as one factor in determining whether to transmit a request to enter the idle state, as described above. In this case, the UI information need not be sent separately to the eNB.

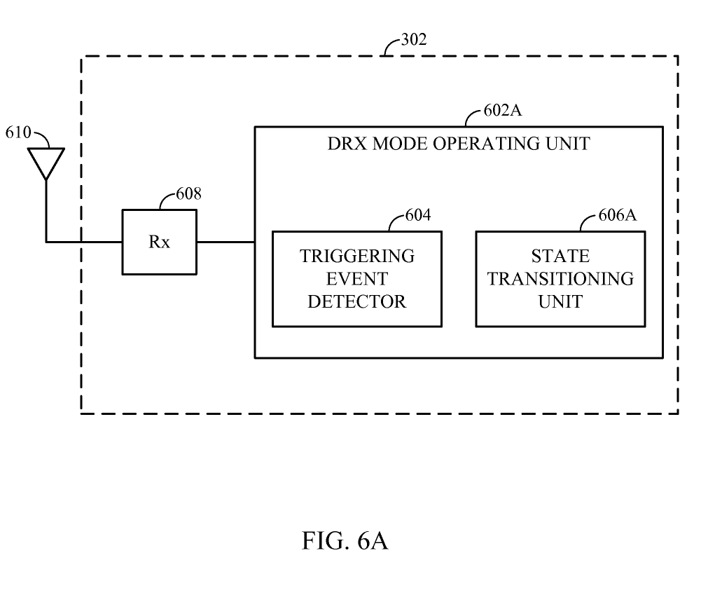

FIG. 6 is a flow diagram of example operations 600, which may be performed by an apparatus, such as a UE, for transitioning from a DRX connected state to an idle state. The operations may begin, at 602, with the apparatus operating in a DRX mode in which a receiver of the apparatus is turned on (i.e., powered up) during certain periods for receiving data from a first base station (BS), and the receiver is turned off (i.e., powered down) during other periods. At 602, the apparatus is in a connected state (e.g., the RRC connected state) with the first BS. At 604, the apparatus may detect a triggering event before expiration of an inactivity timer. The apparatus may transition from the connected state to an idle state at 606, based on the detection at 604.

According to certain aspects, the apparatus may detect the triggering event at 604 by determining that a handover to a second BS is imminent. The apparatus may transmit, to the first BS, a request to enter the idle state before the handover to the second BS. For certain aspects, the request may be transmitted in a media access control (MAC) header along with uplink (UL) data. For certain aspects, the apparatus may then receive a response, from the first BS, before transitioning from the connected state to the idle state at 606. For other aspects, the transitioning from the connected state to the idle state at 606 occurs without waiting for a response to the transmitted request. In other words, the apparatus may unilaterally transition from the connected state to the idle state at 606, after transmitting the request to enter the idle state, for certain aspects. The apparatus may perform cell reselection to the second BS or a third BS while the apparatus is in the idle state.

For certain aspects, the apparatus may determine a reference signal received power (RSRP) associated with at least the first BS (e.g., the first BS and/or the second BS). In this case, the apparatus may determine that the handover to the second BS is imminent based on the RSRP associated with the at least the first BS. For example, the apparatus may determine that the handover to the second BS is imminent based on the RSRP associated with the first BS and with the RSRP associated with the second BS. The apparatus may then transmit a measurement report to the first BS based on the RSRP along with the request to enter the idle state.

According to certain aspects, the apparatus may detect the triggering event at 604 by determining that the idle state would be more efficient (e.g., in terms of power consumption) than the connected state for the apparatus. For other aspects, the apparatus may detect the triggering event at 604 by receiving an indication from the first BS for the apparatus to transition to the idle state. In this case, the apparatus may transmit information indicating a status of a user interface (UI) of the apparatus to the first BS before receiving the indication from the first BS for the apparatus to transition to the idle status. For certain aspects, the UI may comprise a display of the apparatus, and the information may indicate that the display is powered on or off

For certain aspects, the apparatus may detect the triggering event by determining that a connection between the apparatus and the first BS has failed. The apparatus may perform cell reselection of a second BS and may perform a random access channel (RACH) procedure with the second BS based on the cell reselection. Performing the RACH procedure may comprise transmitting an RACH message 3 including a request to enter the idle state to the second BS. For certain aspects, the RACH message 3 may also include at least one of a physical cell identifier (PCI) of the first BS or a cell radio network temporary identifier (C-RNTI) of the first BS. After transmitting the RACH message 3, the apparatus may receive an RACH message 4, wherein transitioning to the idle state at 606 occurs after receiving the RACH message 4 without performing a radio resource control (RRC) connection setup or a remainder of a handover procedure to the second BS.

According to certain aspects, the apparatus may detect the triggering event at 604 by determining that the apparatus has lost UL synchronization with the first BS. The apparatus may then perform an RACH procedure with the first BS. For certain aspects, the apparatus may perform the RACH procedure by transmitting an RACH message 3 including a request to enter the idle state.

For other aspects, the apparatus may detect the triggering event by identifying mobility of the apparatus (i.e., determining that the apparatus is moving, especially from or to the coverage area of different cells). In this case, the apparatus may determine a reference signal received power (RSRP) associated with the first BS. The apparatus may identify its mobility by determining that the RSRP associated with the first BS is below a threshold or is decreasing.

The operations 600 described above may be performed by any suitable components or other means capable of performing the corresponding functions of FIG. 6. For example, operations 600 illustrated in FIG. 6 correspond to components 600A illustrated in FIG. 6A. In FIG. 6A, a DRX mode operating unit 602A may operate in a DRX mode in which a receiver 608 of an apparatus (e.g., a UE 302) is powered on during certain periods for receiving data from a first BS (e.g., a source eNB 304 or a serving eNB), the receiver is powered off during other periods, and the apparatus is in a connected state with the first BS. A triggering event detector 604A may detect a triggering event before expiration of an inactivity timer. A state transitioning unit 606A may transition the apparatus from the connected state to the idle state based on the detection in the triggering event detector 604A.

For certain aspects, the triggering event detector 604A and/or the state transitioning unit 606A may be integrated with the DRX mode operating unit 602A, as shown in FIG. 6A. For certain aspects, the DRX mode operating unit 602A may be part of a processing system, such as the processor 270 of the receiver system 250 in FIG. 2. The receiver 608, which may function similar to the receivers 254, may receive signals via an antenna 610, which may function similar to the antennas 252 of FIG. 2.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in the figures, those operations may have corresponding counterpart means-plus-function components with similar numbering.

More particularly, means for transmitting, mean for sending, or means for forwarding may comprise a transmitter, such as the transmitter 254 illustrated in FIG. 2. Means for receiving may comprise a receiver, such as the receiver 254 illustrated in FIG. 2. Means for determining, means for processing, means for operating, means for detecting, means for performing, or means for transitioning may comprise a processing system having at least one processor, such as the processor 270 illustrated in FIG. 2. Means for storing may comprise a memory, such as the memory 272 of FIG. 2.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the aspects disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure. Thus, the present disclosure is not intended to be limited to the aspects shown herein but is to be accorded the widest scope consistent with the principles and novel features disclosed herein.

1. A method for wireless communications, comprising:
operating in a discontinuous reception (DRX) mode in which a receiver of an apparatus is powered on during certain periods for receiving data from a first base station (BS), the receiver is powered off during other periods, and the apparatus is in a connected state with the first BS;
detecting a triggering event before expiration of an inactivity timer; and
transitioning from the connected state to an idle state based on the detection.

2. The method of claim 1, wherein detecting the triggering event comprises determining that a handover to a second BS is imminent.

3. The method of claim 2, further comprising transmitting a request, from the apparatus to the first BS, to enter the idle state before the handover to the second BS.

4. The method of claim 3, further comprising receiving, from the first BS, a response to the transmitted request before transitioning from the connected state to the idle state.

5. The method of claim 3, wherein transmitting the request comprises transmitting the request in a media access control (MAC) header along with uplink (UL) data.

6. The method of claim 3, further comprising:
determining a reference signal received power (RSRP) associated with at least the first BS, wherein determining that the handover to the second BS is imminent is based on the RSRP associated with the at least the first BS; and
transmitting a measurement report to the first BS based on the RSRP along with the request to enter the idle state.

7. The method of claim 3, further comprising performing cell reselection to the second BS while the apparatus is in the idle state.

8. The method of claim 3, wherein the transitioning from the connected state to the idle state occurs without waiting for a response to the transmitted request.

9. The method of claim 1, wherein detecting the triggering event comprises determining that the idle state would be more efficient than the connected state for the apparatus.

10. The method of claim 9, wherein the determining comprises determining that the idle state would be more efficient in terms of power consumption than the connected state for the apparatus.

11. The method of claim 1, wherein detecting the triggering event comprises determining that a connection between the apparatus and the first BS has failed.

12. The method of claim 11, further comprising:
performing cell reselection of a second BS; and
performing a random access channel (RACH) procedure with the second BS based on the cell reselection, wherein performing the RACH procedure comprises transmitting an RACH message 3 including a request to enter the idle state to the second BS.

13. The method of claim 12, wherein the RACH message 3 further comprises at least one of a physical cell identifier (PCI) of the first BS or a cell radio network temporary identifier (C-RNTI) of the first BS.

14. The method of claim 12, further comprising receiving an RACH message 4, wherein transitioning to the idle state occurs after receiving the RACH message 4 without performing a radio resource control (RRC) connection setup or a remainder of a handover procedure to the second BS.

15. The method of claim 1, wherein detecting the triggering event comprises determining that the apparatus has lost uplink (UL) synchronization with the first BS.

16. The method of claim 15, further comprising performing a random access channel (RACH) procedure with the first BS, wherein performing the RACH procedure comprises transmitting an RACH message 3 including a request to enter the idle state.

17. The method of claim 1, wherein detecting the triggering event comprises identifying mobility of the apparatus.

18. The method of claim 17, further comprising determining a reference signal received power (RSRP) associated with the first BS, wherein identifying the mobility of the apparatus comprises determining that the RSRP associated with the first BS is below a threshold or is decreasing.

19. The method of claim 1, wherein detecting the triggering event comprises receiving an indication from the first BS for the apparatus to transition to the idle state.

20. The method of claim 19, further comprising transmitting information indicating a status of a user interface (UI) of the apparatus to the first BS before receiving the indication from the first BS for the apparatus to transition to the idle status.

21. The method of claim 20, wherein the UI comprises a display of the apparatus and wherein the information indicates that the display is powered off.

22. An apparatus for wireless communications, comprising:
a receiver; and
a processing system configured to:
operate in a discontinuous reception (DRX) mode in which the receiver is powered on during certain periods for receiving data from a first base station (BS), the receiver is powered off during other periods, and the apparatus is in a connected state with the first BS;
detect a triggering event before expiration of an inactivity timer; and
transition the apparatus from the connected state to an idle state based on the detection.

23. The apparatus of claim 22, wherein the processing system is configured to detect the triggering event by determining that a handover to a second BS is imminent.

24. The apparatus of claim 23, further comprising a transmitter configured to transmit, to the first BS, a request to enter the idle state before the handover to the second BS.

25. The apparatus of claim 24, wherein the receiver is configured to receive, from the first BS, a response to the transmitted request before the transition from the connected state to the idle state.

26. The apparatus of claim 24, wherein the transmitter is configured to transmit the request in a media access control (MAC) header along with uplink (UL) data.

27. The apparatus of claim 24, wherein the processing system is further configured to determine a reference signal received power (RSRP) associated with at least the first BS, wherein determining that the handover to the second BS is imminent is based on the RSRP associated with the at least the first BS and wherein the transmitter is configured to transmit a measurement report to the first BS based on the RSRP along with the request to enter the idle state.

28. The apparatus of claim 24, wherein the processing system is further configured to perform cell reselection to the second BS while the apparatus is in the idle state.

29. The apparatus of claim 24, wherein the processing system is configured to transition from the connected state to the idle state without waiting for the receiver to receive a response to the transmitted request.

30. The apparatus of claim 22, wherein the processing system is configured to detect the triggering event by determining that the idle state would be more efficient than the connected state for the apparatus.

31. The apparatus of claim 30, wherein the determining comprises determining that the idle state would be more efficient in terms of power consumption than the connected state for the apparatus.

32. The apparatus of claim 22, wherein the processing system is configured to detect the triggering event by determining that a connection between the apparatus and the first BS has failed.

33. The apparatus of claim 32, further comprising a transmitter, wherein the processing system is further configured to:
perform cell reselection of a second BS; and
perform a random access channel (RACH) procedure with the second BS based on the cell reselection, wherein the transmitter is configured to transmit an RACH message 3 including a request to enter the idle state to the second BS.

34. The apparatus of claim 33, wherein the RACH message 3 further comprises at least one of a physical cell identifier (PCI) of the first BS or a cell radio network temporary identifier (C-RNTI) of the first BS.

35. The apparatus of claim 33, wherein the receiver is further configured to receive an RACH message 4, wherein the processing system is configured to transition to the idle state after the reception of the RACH message 4 without performing a radio resource control (RRC) connection setup or a remainder of a handover procedure to the second BS.

36. The apparatus of claim 22, wherein the processing system is configured to detect the triggering event by determining that the apparatus has lost uplink (UL) synchronization with the first BS.

37. The apparatus of claim 36, further comprising a transmitter, wherein the processing system is configured to perform a random access channel (RACH) procedure with the first BS and wherein the transmitter is configured to transmit an RACH message 3 including a request to enter the idle state.

38. The apparatus of claim 22, wherein the processing system is configured to detect the triggering event by identifying mobility of the apparatus.

39. The apparatus of claim 38, wherein the processing system is further configured to determine a reference signal received power (RSRP) associated with the first BS and wherein identifying the mobility of the apparatus comprises determining that the RSRP associated with the first BS is below a threshold or is decreasing.

40. The apparatus of claim 22, wherein the receiver is configured to receive an indication from the first BS for the apparatus to transition to the idle state and wherein the triggering event is the reception of the indication.

41. The apparatus of claim 40, further comprising:
a user interface (UI); and
a transmitter configured to transmit information indicating a status of the UI to the first BS before the receiver receives the indication from the first BS for the apparatus to transition to the idle status.

42. The apparatus of claim 41, wherein the UI comprises a display and wherein the information indicates that the display is powered off.

43. An apparatus for wireless communications, comprising:
means for operating in a discontinuous reception (DRX) mode in which a receiver of the apparatus is powered on during certain periods for receiving data from a first base station (BS), the receiver is powered off during other periods, and the apparatus is in a connected state with the first BS;
means for detecting a triggering event before expiration of an inactivity timer; and
means for transitioning from the connected state to an idle state based on the detection.

44. A computer-program product for wireless communications, comprising:
a computer-readable medium comprising code for:
operating in a discontinuous reception (DRX) mode in which a receiver of an apparatus is powered on during certain periods for receiving data from a first base station (BS), the receiver is powered off during other periods, and the apparatus is in a connected state with the first BS;
detecting a triggering event before expiration of an inactivity timer; and
transitioning from the connected state to an idle state based on the detection.
